(19) United States
(12) Patent Application Publication
(10) Pub. No.: US 2024/0340843 A1
(43) Pub. Date: Oct. 10, 2024

(54) METHOD AND APPARATUS RELATED TO POSITIONING

(71) Applicant: Samsung Electronics Co., Ltd., Suwon-si (KR)

(72) Inventors: Qi XIONG, Beijing (CN); Pengru LI, Beijing (CN); Feifei SUN, Beijing (CN)

(21) Appl. No.: 18/623,384

(22) Filed: Apr. 1, 2024

(30) Foreign Application Priority Data
Apr. 4, 2023 (CN) 202310355407.5

(51) Int. Cl. H04W 64/00; H04L 5/00; H04W 72/0453

(52) U.S. Cl. CPC H04W 64/00; H04L 5/0012; H04L 5/0051; H04W 72/0453

(57) ABSTRACT

The disclosure relates to a fifth generation (5G) or sixth generation (6G) communication system for supporting a higher data transmission rate. A method performed by user equipment (UE) in a communication system is provided. The method includes receiving first configuration information related to positioning signal, determining a first frequency band and a second frequency band based on the first configuration information, determining resource configuration information of a third frequency band based on the first frequency band and the second frequency band, and transmitting and/or receiving the positioning signal based on the resource configuration information of the third frequency band.

### CROSS-REFERENCE TO RELATED APPLICATION(S)

This application is based on and claims priority under 35 U.S.C. § 119(a) of a Chinese patent application number 202310355407.5, filed on Apr. 4, 2023, in the Chinese Intellectual Property Office, the disclosure of which is incorporated by reference herein in its entirety.

### BACKGROUND

### 1. Field

The disclosure relates to a method and apparatus related to positioning in a wireless communication system.

### 2. Description of Related Art

Fifth generation (5G) mobile communication technologies define broad frequency bands such that high transmission rates and new services are possible, and can be implemented not only in “Sub 6 giga hertz (GHz)” bands, such as 3.5 GHz, but also in “Above 6 GHz” bands referred to as mmWave including 28 GHz and 39 GHz. In addition, it has been considered to implement sixth generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio user equipment (NR UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEG) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

In order to meet the increasing demand for wireless data communication services since the deployment of 4G communication systems, efforts have been made to develop improved 5G or pre-5G communication systems. Therefore, 5G or pre-5G communication systems are also called “Beyond 4G networks” or “Post-long term evolution (LTE) systems”.

In order to achieve a higher data rate, 5G communication systems are implemented in higher frequency (millimeter, mmWave) bands, e.g., 60 GHz bands. In order to reduce propagation loss of radio waves and increase a transmission distance, technologies, such as beamforming, massive multiple-input multiple-output (MIMO), full-dimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, or the like.

In 5G systems, hybrid frequency shift keying (FSK) and quadrature amplitude (QAM) modulation frequency quadrature amplitude modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for positioning in a wireless communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving first configuration information related to positioning signal, determining a first frequency band and a second frequency band based on the first configuration information, determining resource configuration information of a third frequency band based on the first frequency band and the second frequency band, and transmitting and/or receiving the positioning signal based on the resource configuration information of the third frequency band.

In an implementation, the configuration information related to positioning signal includes at least one of:
positioning signal configuration information associated with frequency band aggregation,
indication information for activating frequency band aggregation,
configuration information of a plurality of positioning frequency layers (PFLs) for frequency band aggregation, and
configuration information related to a sounding reference signal (SRS) for positioning transmission window (STW).

In an implementation, determining a first frequency band and a second frequency band based on the configuration information related to positioning signal comprises:
determining the first frequency band or the second frequency band based on indication information related to the first frequency band or the second frequency band in the configuration information related to positioning signal, or
determining the first frequency band or the second frequency band based on positioning reference signal (PRS) resource set or PRS resources included in the configuration information related to positioning signal, or a cell index or TRP index associated with PFL configuration information.

In an implementation, determining the first frequency band or the second frequency band based on positioning reference signal PRS resource set or PRS resources included in the configuration information related to positioning signal comprises:

determining the first frequency band or the second frequency band based on at least one of the number of positioning reference signal (PRS) resource sets or PRS resources in the configuration related to the positioning signal, a frequency domain starting location, the size of start physical resource block physical resource block (PRB), an interval between the start PRB and a reference point (Point A), and bandwidth size.

In an implementation, the method further comprises determining resource configuration information of the first frequency band and the second frequency band based on the configuration information related to positioning signal; and

determining resource configuration information of a third frequency band based on the first frequency band and the second frequency band comprises determining the resource configuration information of the third frequency band based on the resource configuration information of the first frequency band and the second frequency band.

In an implementation, determining resource configuration information of the third frequency band based on the resource configuration information of the first frequency band and the second frequency band comprises:
determining time domain configuration information of the third frequency band according to time domain configuration information of the first frequency band;
and/or

determining frequency domain configuration information of the third frequency band according to frequency domain configuration information of the first frequency band and the second frequency band.

In an implementation, determining frequency domain configuration information of the third frequency band based on the frequency domain configuration information of the first frequency band and the second frequency band comprises:
determining a frequency domain starting location according to a starting location of a PRS resource or PRS resource set of the first frequency band, and/or determining the bandwidth size of the third frequency band as one of:

the sum of bandwidths of the first frequency band and the second frequency band; and
the sum of the bandwidths of the first frequency band and the second frequency band minus overlapping or colliding bandwidths of the first frequency band and the second frequency band.

In an implementation, the configuration information related to the sounding reference signal (SRS) for positioning transmission window (STW) includes at least one of:
a time domain length of STW,
a time domain starting location of STW,
a periodicity of STW, and
priority information related to signal transmission in STW.

In an implementation, the priority information includes at least one of:
a priority of the sounding reference signal SRS for positioning compared with other signals,
power allocation priority related to signal.

In an implementation, the priority information is related to the colliding or overlapping between the sounding reference signal SRS for positioning and the transmission of other signals in the STW, the conflicting or overlapping includes one of:
an interval between time domain units of the sounding reference signal SRS for positioning and other signals is less than a first threshold, and
an interval between the time domain units of the STW and the time domain units of other signals is less than a second threshold.

According to embodiments of the disclosure, a method performed by a UE in a wireless communication system is provided. The method includes receiving configuration information related to positioning signal, determining positioning reference signal (PRS) frequency hopping based on the configuration information, and if a first condition related to interrupting signal or interrupting time period is satisfied, canceling or dropping a reception of a part or all of the PRS frequency hopping.

In an implementation, the interrupting signal includes random access related signal.

The interrupting time period includes period related to a random access response RAR window, or period related to a contention resolution timer.

In an implementation, the first condition includes at least one of:
an activated bandwidth portion BWP corresponding to the PRS frequency hopping carries interrupting signal or interrupting time period,
the PRS frequency hopping overlaps or collides with the interrupting signal or interrupting time period in time domain and/or frequency domain,
an interval between the PRS frequency hopping and the interrupting signal or interrupting time period in time domain and/or frequency domain is less than a third threshold, and
the interrupting signal adding a fourth threshold in time domain or frequency domain overlaps or collides with the PRS frequency hopping.

In an implementation, the third threshold or the fourth threshold is related to at least one of preparation time for preparing to receive or transmit the interrupting signal, switch time for switching to a frequency domain location for receiving the interrupting signal, time for canceling the reception of the PRS frequency hopping, or a frequency domain interval between different frequency hoppings.

In an implementation, the method further comprises:

transmitting information related to received PRS frequency hopping or the PRS frequency hopping cancelled receiving to the base station.

In an implementation, the information includes at least one of a cancelled frequency hopping index, a logic index of the cancelled frequency hopping in a frequency hopping group, an actually received frequency hopping index, or a logic index of an uncancelled frequency hopping in the frequency hopping group.

In accordance with another aspect of the disclosure, a method performed by a UE in a wireless communication system is provided. The method includes determining a plurality of frequency domain locations related to positioning signal, acquiring measurement results of the plurality of frequency domain locations, and reporting first information related to the measurement result of each of the plurality of frequency domain locations to a base station.

In an implementation, the method further comprises reporting measurement results of other frequency domain locations among the plurality of frequency domain locations based on a measurement result of a reference frequency domain location among the plurality of frequency domain locations, wherein the reference frequency domain location is the maximum or minimum frequency domain location among the plurality of frequency domain locations, or an indicated reference frequency domain location.

In an implementation, determining the plurality of frequency domain locations related to positioning signal comprises:
obtaining the plurality of frequency domain locations by dividing a bandwidth occupied by the positioning signal at equal intervals according to a configured first number N,
obtaining the plurality of frequency domain locations by dividing a bandwidth occupied by the positioning signal according to a configured frequency domain interval, or
determining the plurality of frequency domain locations based on information related to a plurality of sub-carriers.

In an implementation, the measurement result includes a phase measurement value of the reference frequency domain location, and/or difference between phase measurement values of other frequency domain locations and the phase measurement value of the reference frequency domain location.

In an implementation, the method further comprises reporting indication information of a frequency domain location corresponding to the first information to the base station.

In accordance with another aspect of the disclosure, a method performed by a base station in a wireless communication system is provided. The method includes transmitting first configuration information related to positioning signal, transmitting and/or receiving the positioning signal based on the first configuration information, wherein the first configuration information is used to determine a first frequency band and a second frequency band, and resource configuration information of a third frequency band related to the first frequency band and the second frequency band, and wherein the positioning signal is transmitted and/or received based on the resource configuration information of the third frequency band.

In an implementation, the configuration information related to positioning signal includes at least one of positioning signal configuration information associated with frequency band aggregation, indication information for activating frequency band aggregation, configuration information of a plurality of positioning frequency layers (PFLs) for frequency band aggregation, and configuration information related to a sounding reference signal (SRS) for positioning transmission window (STW).

In accordance with another aspect of the disclosure, a method performed by a UE in a wireless communication system is provided. The method includes transmitting first configuration information related to positioning signal, and transmitting positioning reference signal (PRS) frequency hopping based on the first configuration information, if a first condition related to interrupting signal or interrupting time period is satisfied, a reception of a part or all of PRS frequency hopping is cancelled or dropped.

In an implementation, the first condition includes at least one of:
an activated bandwidth portion BWP corresponding to the PRS frequency hopping carries interrupting signal or interrupting time period,
the PRS frequency hopping overlaps or collides with the interrupting signal or interrupting time period in time domain and/or frequency domain,
an interval between the PRS frequency hopping and the interrupting signal or interrupting time period in time domain and/or frequency domain is less than a third threshold, and
the interrupting signal adding a fourth threshold in time domain or frequency domain overlaps or collides with the PRS frequency hopping.

According to embodiments of the disclosure, a method performed by a UE in a wireless communication system is provided. The method includes transmitting information related to a plurality of frequency domain locations related to measurement of positioning signal, and receiving first information related to a measurement result of each of the plurality of frequency domain locations.

In an implementation, the information related to the multiple frequency domain locations includes at least one of:
information related to a first number N of the plurality of frequency domain locations, or
a frequency domain interval related to the plurality of frequency domain locations; or
information related to a plurality of sub-carriers.

According to an embodiment of the disclosure, a communication device is provided. The communication device includes a transceiver, configured to receive and/or transmit a signal, memory storing one or more computer programs and one or more processors communicatively coupled to the transceiver and the memory, wherein the one or more computer programs include computer-executable instructions that, when executed by the one or more processors, cause the communication device to receive first configuration information related to positioning signal, determine a first frequency band and a second frequency band based on the first configuration information, determining resource configuration information of a third frequency band based on the first frequency band and the second frequency band, and transmitting and/or receiving the positioning signal based on the resource configuration information of the third frequency band.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram of a wireless network according to an embodiment of the disclosure;

FIG. 2A illustrates a wireless transmission path according to an embodiment of the disclosure;

FIG. 2B illustrates a wireless reception path according to an embodiment of the disclosure;

FIG. 3A illustrates a user equipment (UE) according to an embodiment of the disclosure;

FIG. 3B illustrates a base station according to an embodiment of the disclosure;

FIG. 4 is a block diagram of a communication device for performing a method according to an embodiment of the disclosure;

FIG. 5 is a schematic diagram illustrating PRS frequency hopping and interrupting signal or interrupting time period according to an embodiment of the disclosure;

FIG. 6 is a schematic diagram of frequency band aggregation according to an embodiment of the disclosure;

FIG. 7 is a schematic diagram of frequency band aggregation according to an embodiment of the disclosure;

FIG. 8 is a schematic diagram of frequency band aggregation according to an embodiment of the disclosure;

FIG. 9 is a schematic diagram of frequency band aggregation according to an embodiment of the disclosure; and

FIG. 10 illustrates a schematic diagram of a SRSpos transmission window according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It should be understood that the singular forms “a,” “an,” and “the” include plural referents unless the context clearly dictates otherwise. Thus, for example, reference to “a component surface” includes reference to one or more of such surfaces.

The term “include” or “may include” which may be used in describing various embodiments of the disclosure refers to the existence of a corresponding disclosed function, operation or component which can be used in various embodiments of the disclosure, rather than limiting one or more additional functions, operations, or components. In addition, the terms, such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of terms listed. For example, “A or B” may include A, may include B, or may include both A and B.

Unless otherwise specified, all of the terms which are used herein (including the technical or scientific terms) have the same meanings as those that are generally understood by a person having ordinary knowledge in the art to which the disclosure pertains. The terms defined in a generally used dictionary must be understood to have meanings identical with those used in the context of a related art, and are not to be construed to have ideal or excessively formal meanings unless they are obviously specified in the disclosure.

The technical solution of the application can be applied to various communication systems, for example: a global system for mobile communications (GSM) system, a code division multiple access (CDMA) system, a wideband code division multiple access (WCDMA) system, general packet radio service (GPRS), a long term evolution (LTE) system, an LTE frequency division duplex (FDD) system, LTE time division duplex (TDD), a universal mobile telecommunication system (UMTS), a worldwide interoperability for microwave access (WiMAX) communication system, a fifth generation (5G) system or new radio (NR), or the like. In addition, the technical solution of the embodiments of the disclosure can be applied to future-oriented communication technology.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

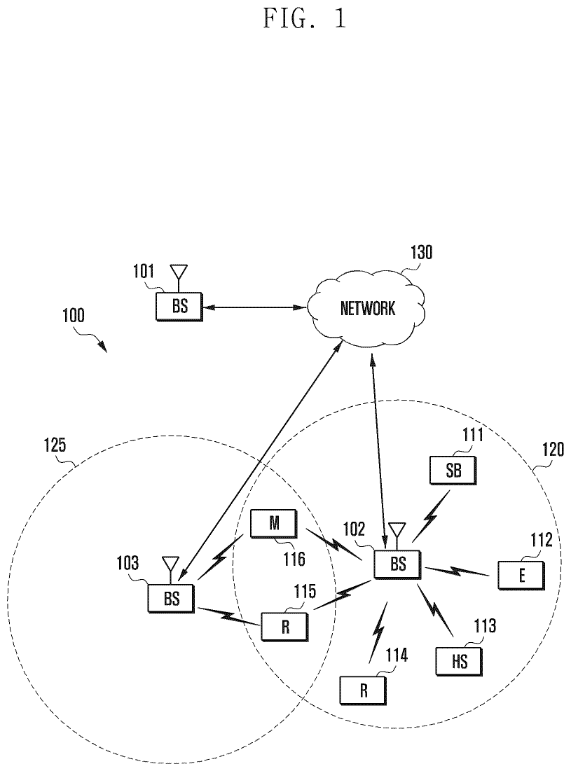

FIG. 1 is a schematic diagram of a wireless network according to an embodiment of the disclosure.

Referring to FIG. 1, the embodiment of a wireless network 100 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet protocol (IP) network 130, such as the Internet, a private IP network, or other data networks.

Depending on a type of the network, other well-known terms, such as “base station” or “access point” can be used instead of “gNodeB” or “gNB”. For convenience, the terms “gNodeB” and “gNB” are used in this patent document to refer to network infrastructure components that provide wireless access for remote terminals. Moreover, depending on the type of the network, other well-known terms, such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of user equipments (UEs) within a coverage area 120 of gNB 102. The first plurality of UEs include a UE 111, which may be located in a small business (SB), a UE 112, which may be located in an enterprise (E), a UE 113, which may be located in a WiFi Hotspot (HS), a UE 114, which may be located in a first residence (R); a UE 115, which may be located in a second residence (R), a UE 116, which may be a mobile device (M), such as a cellular phone, a wireless laptop computer, a wireless PDA, or the like. gNB 103 provides wireless broadband access to network 130 for a second plurality of UEs within a coverage area 125 of gNB 103. The second plurality of UEs include a UE 115 and a UE 116. In some embodiments of the disclosure, one or more of gNBs 101-103 can communicate with each other and with UEs 111-116 using 5G, long term evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described below, one or more of gNB 101, gNB 102, and gNB 103 include a two-dimensional (2D) antenna array as described in embodiments of the disclosure. In some embodiments of the disclosure, one or more of gNB 101, gNB 102, and gNB 103 support codebook designs and structures for systems with 2D antenna arrays.

Referring to FIG. 1, an example of the wireless network 100, various changes can be made to FIG. 1. For example, the wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

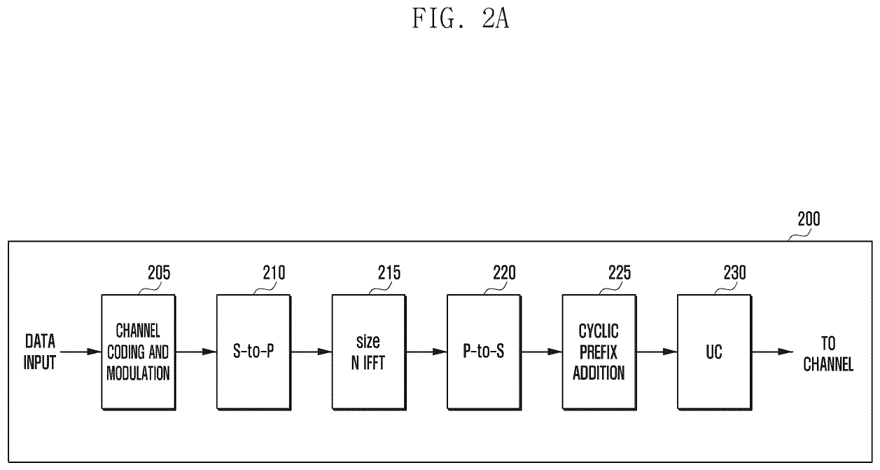

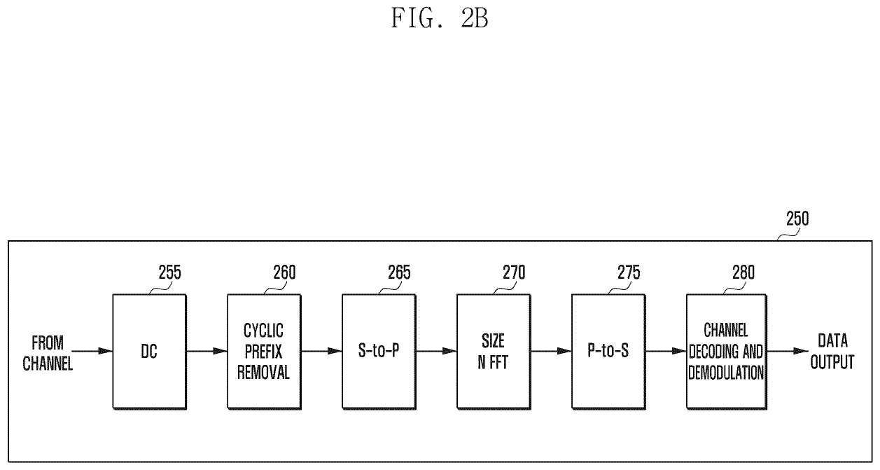

FIGS. 2A and 2B illustrate wireless transmission and reception paths according to various embodiments of the disclosure.

Referring to FIGS. 2A and 2B, in the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments of the disclosure, the reception path 250 is configured to support codebook designs and structures for systems with 2D antenna arrays as described in embodiments of the disclosure.

The transmission path 200 includes a channel coding and modulation block 205, a serial-to-parallel (S-to-P) block 210, a size N inverse fast Fourier transform (IFFT) block 215, a parallel-to-serial (P-to-S) block 220, a cyclic prefix addition block 225, and an up-converter (UC) 230. The reception path 250 includes a down-converter (DC) 255, a cyclic prefix removal block 260, a serial-to-parallel (S-to-P) block 265, a size N fast Fourier transform (FFT) block 270, a parallel-to-serial (P-to-S) block 275, and a channel decoding and demodulation block 280.

In the transmission path 200, the channel coding and modulation block 205 receives a set of information bits, applies coding (such as low density parity check (LDPC) coding), and modulates the input bits (such as using quadrature phase shift keying (QPSK) or quadrature amplitude modulation (QAM)) to generate a sequence of frequency-domain modulated symbols. The serial-to-parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The parallel-to-serial block 220 converts (such as multiplexes) parallel time-domain output symbols from the size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The serial-to-parallel block 265 converts the time-domain baseband signal into a parallel time-domain signal. The size N FFT block 270 performs an FFT algorithm to generate N parallel frequency-domain signals. The parallel-to-serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as discrete Fourier transform (DFT) and inverse discrete Fourier transform (IDFT) functions. It should be understood that for DFT and IDFT functions, the value of variable N may be any integer (such as 1, 2, 3, 4, or the like), while for FFT and IFFT functions, the value of variable N may be any integer which is a power of 2 (such as 1, 2, 4, 8, 16, or the like).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

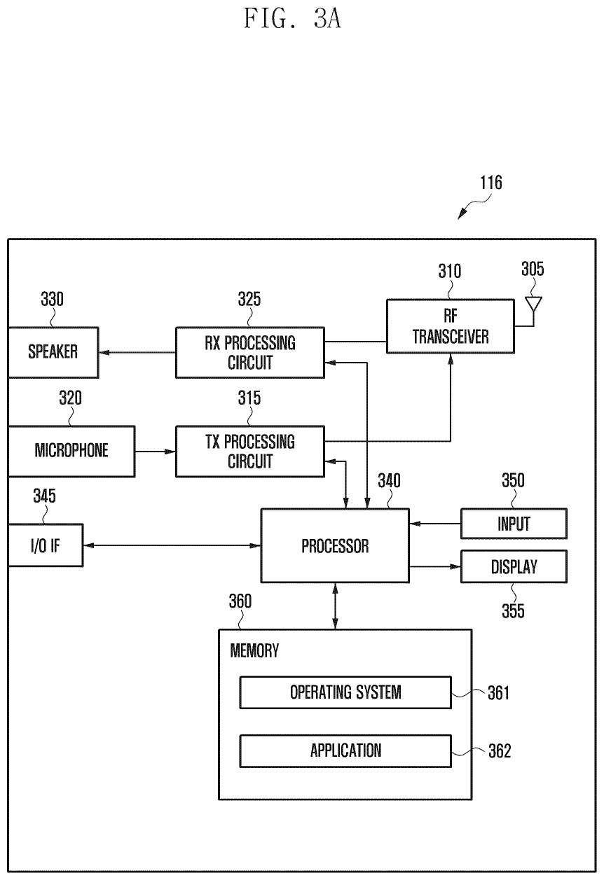

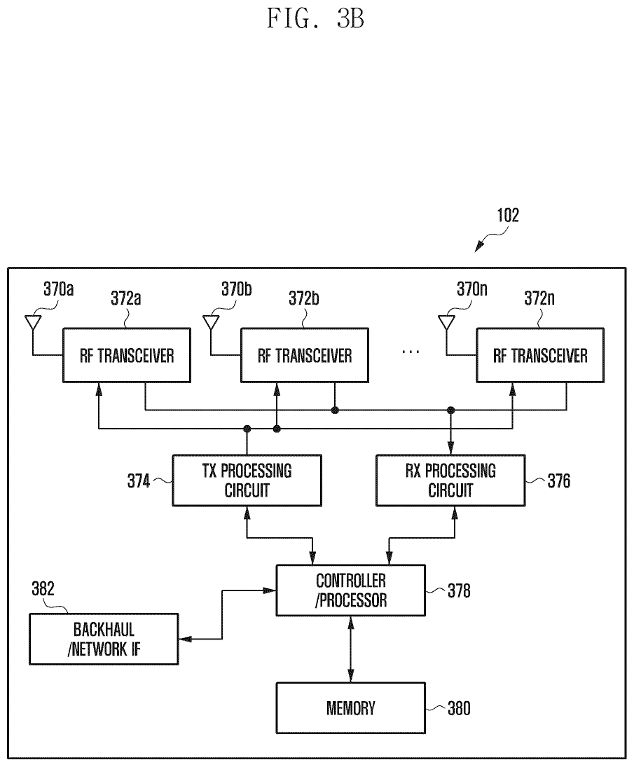

FIG. 3A illustrates a UE according to an embodiment of the disclosure.

Referring to FIG. 3A, the UE 116 is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband/or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband/or IF signal. The RF transceiver 310 receives the outgoing processed baseband/or IF signal from the TX processing circuit 315 and up-converts the baseband/or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments of the disclosure, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments of the disclosure, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices, such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include random access memory (RAM), while another part of the memory 360 can include flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates a gNB according to an embodiment of the disclosure.

Referring to FIG. 3B, the gNB 102 is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

Referring to FIG. 3B, gNB 102 includes a plurality of antennas 370a-370n, a plurality of RF transceivers 372a-372n, a transmission (TX) processing circuit 374, and a reception (RX) processing circuit 376. In certain embodiments of the disclosure, one or more of the plurality of antennas 370a-370n include a 2D antenna array. gNB 102 also includes a controller/processor 378, memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband/or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband/or IF signal. RF transceivers 372a-372n receive the outgoing processed baseband/or IF signal from TX processing circuit 374 and up-convert the baseband/or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a blind interference sensing (BIS) process, such as that performed through a BIS algorithm, and decode a received signal from which an interference signal is subtracted. A controller/processor 378 may support any of a variety of other functions in gNB 102. In some embodiments of the disclosure, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments of the disclosure, the controller/processor 378 supports communication between entities, such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the processor/controller 378. A part of the memory 380 can include an RAM, while another part of the memory 380 can include flash memory or other ROMs. In some embodiments of the disclosure, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (also called time unit) in the application may be: an OFDM symbol, an OFDM symbol group (including multiple OFDM symbols), a slot, a slot group (including multiple slots), a subframe, a subframe group (including multiple subframes), a system frame, and a system frame group (including multiple system frames), or may be an absolute time unit, such as 1 millisecond, 1 second, or the like. The time unit may also be a combination of various granularities, such as N1 slots plus N2 OFDM symbols.

A frequency domain unit (also called frequency unit) in the application may be: a sub-carrier, a sub-carrier group (including multiple sub-carriers), a resource block (RB), which may also be called a physical resource block (PRB), a resource block group (including multiple RBs), a bandwidth portion (BWP), a BWP group (including multiple BWPs), a frequency band/carrier, a frequency band group/carrier group, or may be an absolute frequency domain unit, such as 1 Hz, 1 kHz, or the like. The frequency domain unit may also be a combination of multiple granularities, such as M1 PRBs plus M2 sub-carriers.

The various embodiments of the disclosure are further described below in conjunction with the accompanying drawings.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

It should be understood by those skilled in the art that singular forms “a”, “an”, “the”, and “said” may be intended to include plural forms as well, unless otherwise stated. It should be further understood that terms “include/including” used in this specification of the application specify the presence of the stated features, integers, steps, operations, elements and/or components, but not exclusive of the presence or addition of one or more other features, integers, steps, operations, elements, components, and/or combinations thereof. It should be understood that when a component is referred to as being “connected to” or “coupled to” another component, it may be directly connected or coupled to other elements or provided with intervening elements therebetween. In addition, “connected to” or “coupled to” as used herein may include wireless connection or coupling. As used herein, term “and/or” includes all or any of one or more associated listed items or combinations thereof.

It should be understood by those skilled in the art that, unless otherwise specified, all of the terms used herein (including the technical or scientific terms) have the same meanings as those that are generally understood by a person having ordinary knowledge in the art to which the disclosure pertains. It also should be understood that such terms as those defined in a generally used dictionary are to be construed to have the meanings equal to the contextual meanings in the relevant field of art, and are not to be interpreted to have ideal or excessively formal meanings unless clearly defined in the disclosure.

It may be understood by those skilled in the art that the “terminal” and “terminal device” used herein not only include devices with wireless signal receiver, i.e., devices with merely a wireless signal receiver without transmission function, but also include devices including both receiving and transmitting hardware which may perform bidirectional receiving and transmitting on a bidirectional communication link. The device may include cellular or other communication devices which may include a single line display or multi-line display or not include a multi-line display, personal communications service (PCS) which may combine voice, data processing, fax and/or data communication functions, personal digital assistant (PDA) which may include a radio frequency receiver, a pager, internet/intranet visit, network browser, notebook calendar and/or global positioning system (GPS) receiver, a laptop of the related art and/or palm computer or other devices, including laptop of the related art and/or palm computer or other devices equipped with radio frequency receiver. The “terminal” and “terminal device” used herein may be portable, transportable, and can be installed in a vehicle (aviation, maritime and/or land), or may be applicable for and/or configured as operating locally, and/or operating in a distributed manner at any location of the earth and/or space. The “terminal” and “terminal device” used herein may also refer to a communication terminal, an Internet terminal, a music/video player terminal, e.g., PDA, mobile Internet device (MID), and/or a mobile phone with a music/video playing function, or may be smart televisions (TV)s, set-top box, or the like.

Without departing from the scope of the disclosure, the term “send” in the disclosure can be used interchangeably with “transmission”, “report” and “notification”.

The text and drawings are provided as examples only to help readers understand the disclosure. They are not intended and should not be interpreted as limiting the scope of the disclosure in any way. Although certain embodiments and examples have been provided, based on the content disclosed herein, it is obvious to those skilled in the art that modifications to the illustrated embodiments and examples can be made without departing from the scope of the disclosure.

A transmission link of a wireless communication system mainly comprises: a downlink communication link from 5G gNB to user equipment (UE), and an uplink communication link from UE to network.

Nodes used for positioning measurement in a wireless communication system, such as a current wireless communication system, include UE that initiates a location request message, a location management function (LMF) entity that is used for UE positioning and sending positioning assistance data, gNB or transmission-reception point (TRP) that broadcasts the positioning assistance data and performs uplink positioning measurement, and UE that is used for downlink positioning measurement. In addition, the method provided by the disclosure may also be extended to other communication systems, such as automobile communication (V2X), that is, sidelink communication, in which the transmission and reception point or UE can be any device in V2X.

According to an aspect of the disclosure, a method for determining frequency band aggregation for positioning signal is provided. By using this method, configured frequency bands for positioning signal can be used as much as possible, and more flexible and diverse frequency bands for positioning signal transmission and reception can be achieved through frequency band aggregation operation.

There may be multiple configured frequency bands for positioning signal in a communication system. For example, in order to adapt to multiple UE, or to support the positioning of various different types of UE, there may be multiple configured frequency bands, which are located at different frequency domain locations and have different bandwidths, for the transmission or reception of the positioning signal. For example, one or more small-bandwidth frequency bands are included, and/or one or more frequency bands with relatively large bandwidths are included. In a case that the configured frequency band cannot satisfy the current transmission and/or reception situation of the positioning signal, the signaling overhead may be increased if an appropriate frequency band is configured by signaling, and the current frequency band demand cannot be quickly satisfied by configuring the frequency band by signaling.

According to the method of the disclosure, different frequency band demands can be timely satisfied more flexibly by aggregating multiple configured frequency bands (e.g., corresponding to multiple positioning frequency layers (PFLs), corresponding to multiple positioning signal resource sets, or corresponding to multiple sounding reference signal for positioning (SRSpos) configurations).

In an implementation, the method comprises: determining a primary frequency band and one or more secondary frequency bands as well as resource configuration information of the primary frequency band and the secondary frequency bands according to configuration information related to positioning signal (e.g., time domain and/or frequency domain resource configuration information), determining resource configuration information of an aggregated frequency band according to the resource configuration information of the primary frequency band and the secondary frequency band, and transmitting and/or receiving positioning signal according to the determined resource configuration information of the aggregated frequency band.

In an implementation, the primary frequency band corresponds to a primary PFL, and the secondary frequency band corresponds to a secondary PFL.

In an implementation, the configuration information related to positioning signal includes configuration information related to a SRSpos transmission window (STW). Based on the configuration information related to STW, a time window in which the SRSpos transmission of the frequency band aggregation has priority can be determined, and thus the SRSpos transmission can be performed more suitable for the current communication situation.

In an implementation, the configuration information related to STW includes transmission priority information of signals within the STW, and the priority information indicates the priority of the transmission of the SRSpos and other signals (for example, other non-positioning signals). By use of the priority information, when the transmission of the SRSpos overlaps or collides with the transmission of other signals, the signal to be transmitted preferentially or the signal that is cancelled transmitting may be determined.

According to another aspect of the disclosure, a method related to frequency hopping transmission and/or reception of positioning signal is provided. For the convenience of description, the reception of frequency hopping of the positioning signal is used as an example below for illustration. It may be understood that the described method may also be suitable for transmission of frequency hopping of the positioning signal.

In an implementation, the user equipment UE may determine frequency hopping of positioning signal to be received or measured according to the received positioning signal configuration information. However, if the currently activated bandwidth portion (BWP) carries interrupting signal or interrupting time period, the UE may cancel the reception of frequency hopping of positioning signal that overlaps or collides with the interrupting signal or interrupting time period, or give up the reception of frequency hopping of positioning signal that overlaps or collides with the interrupting signal or interrupting time period.

In an implementation, the interrupting signal includes a random access related signal, for example, at least one of preamble or PUSCH transmission corresponding to a message 1 or message A, PUCCH transmission corresponding to a message 3 or message 4 (msg4 or msgB), and PDCCH or PDSCH transmission corresponding to a message 2 (msg2 or message B).

In an implementation, the interrupting time period includes at least one of a random access response window (RAR window) for searching a feedback by a base station to a random access signal transmitted by the UE in random access, or a time period covered by a contention resolution timer.

In an implementation, the frequency hopping of positioning signal that is cancelled reception includes frequency hopping of positioning signal overlapping with the interrupting signal or interrupting time period in time domain or the frequency domain, or the frequency hopping of positioning signal colliding with the interrupting signal or interrupting time period in time domain or the frequency domain.

In an implementation, the occurrence of overlapping or colliding may include at least one of: the frequency hopping of positioning signal overlaps with the time domain or frequency domain resource corresponding to the interrupting signal or interrupting time period, a gap between the frequency hopping of positioning signal and the time domain or frequency domain resource corresponding to the interrupting signal or interrupting time period is less than certain preparation time.

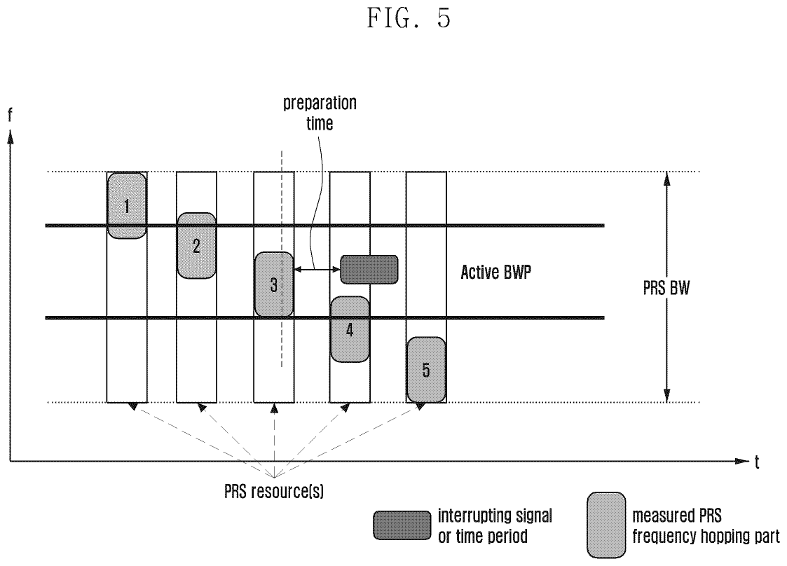

FIG. 5 is a schematic diagram illustrating PRS frequency hopping and interrupting signal or interrupting time period according to an embodiment of the disclosure.

Referring to FIG. 5, in an implementation, the preparation time includes the time for preparing to receive or transmit the interrupting signal, the time for preparing to perform an operation corresponding to the interrupting time period, the time required for giving up or canceling the transmission or reception of the positioning signal, or switch time required for switching between reception of the frequency hopping of positioning signal and the preparation of receiving and/or transmitting the interrupting signal or performing the operation corresponding to the interrupting time period.

The method according to the embodiments of the disclosure further comprises: including an index of cancelled frequency hopping or an index of actually received frequency hopping in a measurement result reported for a frequency hopping reception of positioning signal.

According to another aspect of the disclosure, a method for reporting a measurement result corresponding to positioning signal is provided. The method comprises: determining multiple frequency domain locations corresponding to the positioning signal, where the multiple frequency domain locations include a reference frequency domain location, determining a measurement result of the reference frequency domain location as well as differences between measurement results of other frequency domain locations of the multiple frequency domain locations and the measurement result of the reference frequency domain location, and transmitting a measurement report based on the measurement result of the reference frequency domain location and the differences, wherein the measurement report includes a report block about the reference frequency domain location and the corresponding measurement result, and a report block about other frequency domain locations and corresponding differences.

In an implementation, the reference frequency domain location is the maximum frequency domain location or the minimum frequency domain location in the multiple frequency domain locations.

In an implementation, the multiple frequency domain locations are obtained by dividing a bandwidth occupied by the positioning signal into N sub-bandwidths at equal intervals, wherein the value of N is a value configured by the network. Furthermore, the multiple frequency domain locations may be the frequency domain locations corresponding to middle locations or central sub-carriers of the N sub-bandwidths, or may be a frequency domain location corresponding to the first or last sub-carrier of each of the N sub-bandwidths.

In an implementation, the multiple frequency domain locations are obtained according to a part or all of M sub-bandwidths obtained by dividing the bandwidth occupied by the positioning signal according to configured frequency domain interval. If M is greater than the maximum value Nmax of the number of the frequency domain locations configured by the network for reporting, the multiple frequency domain locations may correspond to Nmax sub-bandwidths with the maximum or minimum frequency domain locations among the M sub-bandwidths, or may be the Nmax sub-bandwidths corresponding to the Nmax maximum or Nmax most accurate measurement results among the M measurement results. The multiple frequency domain locations may be the frequency domain locations corresponding to middle locations or central sub-carriers of the Nmax sub-bandwidths, or may be frequency domain locations corresponding to the first or last sub-carrier of each of the Nmax sub-bandwidths. If M is less than the maximum value Nmax of the number of frequency domain locations configured by the network for reporting, the multiple frequency domain locations may be the frequency domain locations corresponding to middle locations or central sub-carriers of the M sub-bandwidths, or may be a frequency domain location corresponding to the first or last sub-carrier of each sub-bandwidth in M sub-bandwidths.

In an implementation, the multiple frequency domain locations correspond to multiple sub-carriers. For example, the multiple sub-carriers may be sub-carriers corresponding to the sub-carrier index indicated by the base station, or the multiple frequency domain locations are determined by the received sub-carrier index corresponding to the frequency domain location.

In an implementation, the measurement result includes a phase-related measurement result of the sub-carrier.

In an implementation, the multiple frequency domain locations correspond to multiple target sub-carriers, and the target sub-carriers are obtained through a sub-carrier index value indicated by network side.

In an implementation, the target sub-carriers are obtained based on a reference sub-carrier indicated by the network side, wherein the index of the target sub-carriers are obtained according to the index of the reference sub-carrier and the sub-carrier spacing.

In an implementation, the measurement report includes the reference sub-carrier index, a phase measurement value corresponding to the reference sub-carrier, and a report block including the target sub-carrier index and phase differences between the measurement results corresponding to the target sub-carriers and the reference sub-carrier.

It may be understood that the methods described in various aspects and implementations of the embodiments of the disclosure may be performed, for example, by user equipment (UE), and it may also be understood that some corresponding aspects of the methods may be performed by base station side. In the case of describing the operation performed by the UE side, the operation of the base station side may be obtained according to the principles described in the disclosure. Although these principles described in the disclosure are not fully described in combination with the operation of the base station side, they are all included in the scope of the disclosure.

For example, according to an aspect of the embodiments of the disclosure, a method performed by a base station in a communication system is provided, comprising: transmitting configuration information related to positioning signal; transmitting and/or receiving the positioning signal based on the configuration information, wherein the configuration information is used for determining a first frequency band and a second frequency band, as well as resource configuration information of a third frequency band related to the first frequency band and the second frequency band; and the positioning signal is transmitted and/or received based on the resource configuration information of the third frequency band.

In an implementation, the configuration information related to positioning signal includes at least one of positioning signal configuration information associated with frequency band aggregation, indication information for activating frequency band aggregation, configuration information of multiple positioning frequency layers for frequency band aggregation, and configuration information related to a sounding reference signal SRS for positioning transmission window STW.

According to an aspect of the embodiments of the disclosure, a method performed by a base station in a communication system is provided, comprising: transmitting configuration information related to positioning signal; and transmitting positioning reference signal PRS frequency hopping based on the configuration information, wherein if a first condition related to interrupting signal or interrupting time period is satisfied, the reception of a part or all of the PRS frequency hopping is cancelled or dropped.

In an implementation, the first condition includes at least one of:
an activated bandwidth portion BWP corresponding to the PRS frequency hopping carries interrupting signal or interrupting time period;
the PRS frequency hopping overlaps or collides with the interrupting signal or interrupting time period in time domain and/or frequency domain;
a gap between the PRS frequency hopping and the interrupting signal or interrupting time period in time domain and/or frequency domain is less than a third threshold; and
the interrupting signal adding a fourth threshold in time domain or frequency domain overlaps or collides with the PRS frequency hopping.

According to an aspect of the embodiments of the disclosure, a method performed by a base station in a communication system is provided, comprising: transmitting information related to multiple frequency domain locations related to measurement of positioning signal; and receiving first information related to a measurement result of each of the multiple frequency domain locations.

In an implementation, the information related to multiple frequency domain locations includes at least one of:
information related to a first number N of the multiple frequency domain locations; or
a frequency domain interval related to the multiple frequency domain locations; or
information related to multiple sub-carriers.

The technical solution of the disclosure will be described below with reference to the accompanying drawings and examples.

In an implementation of the disclosure, a method and apparatus for transmission and reception of signal for positioning provided by the disclosure are introduced. In a wireless communication system, different UE may have different capacities, for example, some UE supports a large bandwidth, some UE can only support a limited bandwidth, or some UE is configured with a single frequency band of small bandwidth. These UE may not be able to directly measure and/or transmit large-bandwidth signals. Therefore, through the method provided by the disclosure, such UE can perform the transmission and/or reception and measurement of large-bandwidth signals. In the disclosure, signal for positioning and/or reference signal for positioning and/or positioning signal and/or positioning reference signal may have interchangeable meaning, and include one or more of the following combinations:
synchronization signal and PBCH block (SSB);
positioning reference signal (PRS);
channel state information reference signal (CSI-RS);
tracking reference signal (TRS);
sounding reference signal for positioning (SRS for positioning, SRSpos); and
SRS for multi-input multi-output (MIMO).

In the disclosure, when the UE transmits positioning signal, the positioning signal is illustrated with SRSpos as an example. When the UE receives positioning signal, the positioning signal is illustrated with PRS as an example.

When the UE receives and/or transmits positioning signal according to the requirements of positioning services, the operations performed include at least one or a combination of the following:

Receiving configuration information of positioning signal, including at least one of:

A configuration index including configuration information of a positioning signal

### Index of a Positioning Signal

Time domain configuration information of a positioning signal, including at least one of:
the number of time domain units occupied by a positioning signal;
a time interval from a starting location of the time domain units occupied by a positioning signal to a reference time point, wherein the reference time point may be SFN 0, a starting point of the time domain unit where the positioning signal is located, or a time reference location configured by other nodes (e.g., network device);
the size of a configuration period, i.e., M time domain units, indicating that one or more positioning signals in each time domain configuration period have the same time domain and/or frequency domain location and size, i.e., occur repeatedly;
the number of repetitions of a positioning signal, which, alternatively, is the number of repetitions within a certain period;
muting pattern of one or more positioning signals, indicating positioning signals among one or more positioning signals that are not transmitted and/or do not need to be received within a certain period.

Frequency domain configuration information of a positioning signal, including at least one of:
a frequency domain starting location of a positioning signal, including a starting frequency domain unit index, and/or a starting frequency domain unit determined based on a gap of N frequency domain units with respect to a frequency domain reference point, alternatively, the frequency domain starting location of a positioning signal further includes a frequency domain starting location within a certain frequency domain range;
the number and/or locations of frequency domain units occupied by a positioning signal, alternatively, the number of the frequency domain units occupied includes the number and/or locations of frequency domain units occupied within a certain frequency domain range, for example, the number and/or locations of Res (or sub-carriers) occupied in a PRB;
frequency hopping indication (and/or configuration) information and/or frequency hopping pattern configuration information of a positioning reference signal;
the frequency domain reference point may be an absolute frequency domain reference point A (point A), and/or a frequency domain starting location StartPRB of a bandwidth part, alternatively, the bandwidth part is a frequency domain location determined according to the frequency hopping pattern, e.g., a frequency hopping bandwidth part and/or a frequency hopping resource block set;
the certain frequency domain range may be a frequency domain unit, a frequency hopping resource block set of a positioning signal, a frequency hopping bandwidth part of a positioning signal.

When there exists configuration information of multiple positioning signals, for example, including configurations of multiple positioning signals being from configurations of multiple different positioning frequency layers (PFLs) and/or from the configurations of multiple positioning signal resource sets and/or the configurations of multiple SRSpos resources. In this embodiment of the disclosure, the provided method is set forth with the configurations of multiple positioning signals from multiple PFLs as an example. In this case, in order to achieve frequency band aggregation among multiple positioning signals, the determination of time domain and/or frequency domain resource configuration information of a positioning signal includes at least one of the following operations:

Determining that it is satisfied the conditions for frequency band aggregation, which include at least one of:
in the configurations of multiple positioning signals, the time domain configurations are the same, where the time domain configuration includes a time domain periodicity, symbol and/or slot offset, repetition pattern, or the like, where the value of at least one periodicity of the time domain periodicities of configuration of different positioning signals is the least common multiple of values of the time domain periodicities in all of the different configurations of the positioning signals; and/or, the time domain periodicity after frequency band aggregation is the least common multiple of the time domain periodicities in the configurations of multiple positioning signals, preferably, the least common multiple is equal to one value of time domain periodicities in the configurations of multiple positioning signals;
in the configurations of multiple positioning signals, the frequency domain configurations are the same, and the frequency domain configuration comprises: comb size and the like;
carriers or frequency bands at/with which the configurations of multiple positioning signals are located or associated belong to the same TAG (timing advance group). This is mainly to ensure that UE can use the same TA to transmit uplink positioning signals when transmitting SRS in uplink by frequency band aggregation, and the adjustment of timing advance for transmission between different carriers or frequency bands is not required, thus better guaranteeing the uplink transmission by frequency band aggregation;
alternatively, when the UE determines that a condition for frequency band aggregation is satisfied according to at least one of the above conditions, the aggregated frequency band may be used for uplink transmission (e.g., the transmission of SRSpos); in this way, the operation of UE may be simplified, at least, the UE only needs to make decision on the conditions, and if a condition is satisfied, it is considered that the base station has configured an aggregated frequency band available for transmission, and the UE side does not need to perform frequency band aggregation-related operations separately.

Receiving frequency band aggregation related configuration and/or activation indication, including at least one of:
the UE obtains frequency band aggregation related configuration and/or activation through a downlink control signal, and/or downlink MAC CE, and/or higher layer signaling (including RRC and/or LPPa) information, including:
explicit frequency band aggregation indication/activation, for example, 1 bit indication, 1 represents performing frequency band aggregation, and 0 represents not performing frequency band aggregation;
implicit frequency band aggregation indication/activation, when specific positioning signal configuration information appears, the UE determines to perform frequency band aggregation, otherwise, the UE determines not to perform frequency band aggregation; the specific positioning signal configuration information includes that all or a part of positioning configuration signals or a configuration parameter conform(s) to specific configuration parameter value(s), and the included configuration parameters are as described above;
configuration information of multiple PFLs for performing frequency band aggregation (e.g., a PFL index value, a cell index associated with the PFL, and/or transmission and reception point TRP index, or the like).

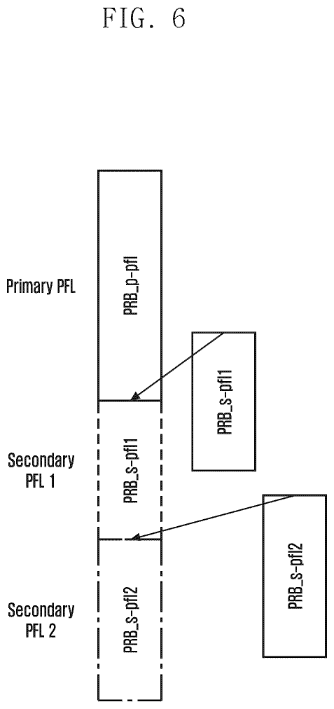

FIG. 6 is a schematic diagram of frequency band aggregation according to an embodiment of the disclosure.

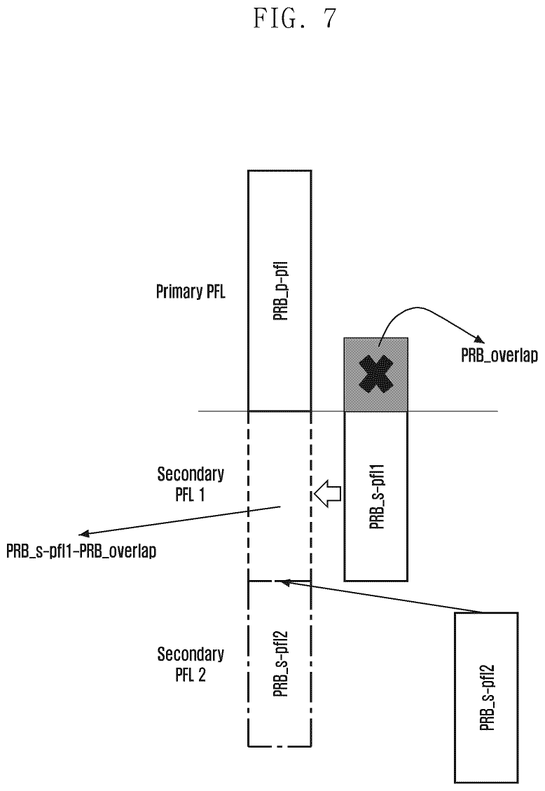

FIG. 7 is a schematic diagram of frequency band aggregation according to an embodiment of the disclosure.

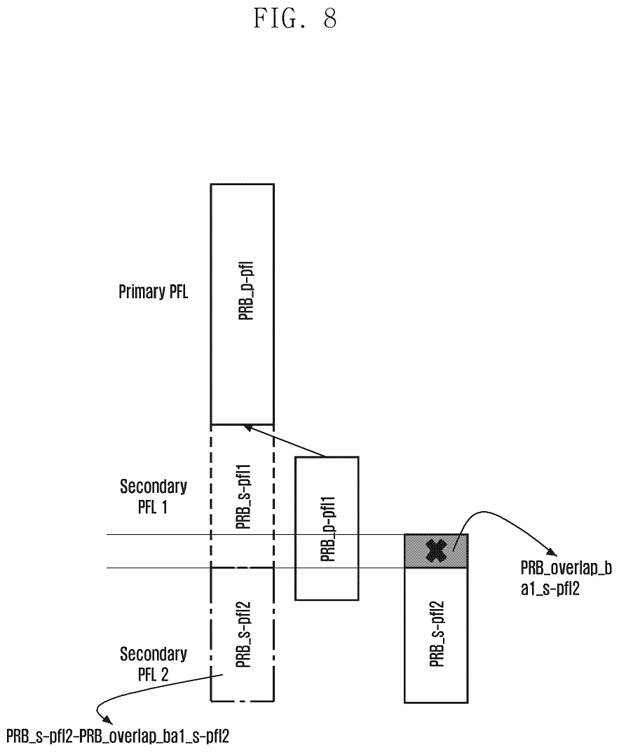

FIG. 8 is a schematic diagram of frequency band aggregation according to an embodiment of the disclosure.

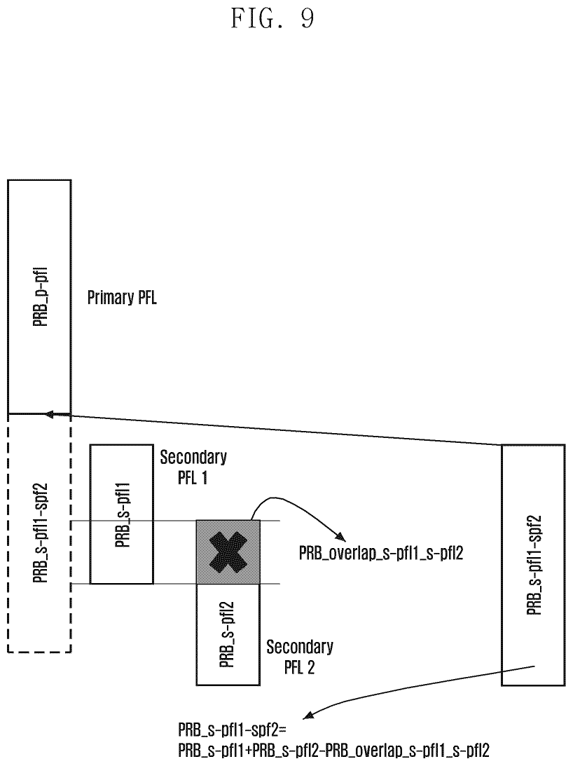

FIG. 9 is a schematic diagram of frequency band aggregation according to an embodiment of the disclosure.

Referring to FIGS. 6, 7,8, and 9, determining primary-PFL (primary PFL, P-PFL) and Secondary-PFL (secondary PFL, S-PFL), which may also be expressed as determining the order of the PFLs, for example, P-PFL is the first PFL, the first S-PFL is the second PFL, and so on. In this embodiment of the disclosure, P-PFL and S-PFL are used as examples to describing the method, a method for specifically determining the P-PFL and/or S-PFL includes at least one of:
receiving an indication on P-PFL or S-PFL, for example, the configuration information of PFL carries 1 bit indication information, 1 represents the PFL is a primary PFL, 0 represents the PFL is a secondary PFL; alternatively, when there are three PFLs for frequency band aggregation, for 1-bit indication information, 1 represents the PFL is a primary PFL, 0 represents the PFL is a secondary PFL, “absent” represents the PFL is a second secondary PFL; or for 2-bit indication information, 11 represents the PFL is a primary PFL, 10 represents the PFL is a first secondary PFL, 01 represents the PFL is a second secondary PFL, 00 represents default, and indication information corresponding to a bit value, which may be extended to the correspondence between other bit values and the indication information;
determining the order of P-PFL and/or S-PFL and/or S-PFL according to a certain rule, and the certain rule includes at least one of:
a descending order of the number of PRS resource sets and/or the number of PRS resources included in the PFL configurations;
a descending order of frequency domain starting locations of the PRS resource sets and/or PRS resources included in PFL configurations, where the frequency domain starting location includes the size of startPRB, and/or the size of a gap value between the starting location and a reference point, and the reference point may be PointA;
a descending order of frequency domain bandwidth size of the PRS resource sets and/or PRS resources included in the PFL configurations;
a descending order of cell indexes and/or TRP indexes associated with the PFL configurations.

Determining time domain and/or frequency domain configuration information of P-PFL and/or S-PFL according to the configuration information.

Determining time domain and/or frequency domain configuration information of the aggregated frequency band based on the determined time domain and/or frequency domain configuration information of P-PFL and/or S-PFL, specifically including at least one of:
the time domain configuration information of the aggregated frequency band is determined according to the time domain configuration information of the PRS resource sets and/or PRS resources included in the P-PFL configurations, where the time domain configuration of the PRS resource set and/or PRS resources of the P-PFL configuration is used as the time domain configuration of the PRS resource set and/or PRS resources of the aggregated frequency band, that is, the P-PFL and the aggregated frequency band have the same time domain configuration of PRS resource set and/or the PRS resources;
the frequency domain configuration information of the aggregated frequency band is determined based on the frequency domain configuration information of P-PFL and/or S-PFL, specifically including at least one of:
the frequency bandwidth of the aggregated frequency band is the sum of the bandwidths of P-PFL and (one or more or all of) S-PFLs, for example, when there are a P-PFL and two S-PFLs, the bandwidth of the aggregated frequency band is PRB_BA=PRB_p-pfl+PRB_s-pfl1+PRB_s-pfl2, as shown in FIG. 6;
the frequency domain bandwidth of the aggregated frequency band is the sum of bandwidth of P-PFL and actually occupied bandwidths of (one or more or all of) S-PFLs (that is, the sum of the bandwidth after removing the frequency domain portions of the S-PFL overlapping or colliding with the P-PFL and the bandwidth of the P-PFL); for example, when there is a P-PFL and two S-PFLs, the bandwidth of the aggregated frequency band is PRB_BA=PRB_p-pfl+PRB_s-pfl1+PRB_s-pfl2−PRB_overlap, as shown in FIG. 7;
alternatively, if an S-PFL overlaps or collides in the frequency domain with the bandwidth of a first aggregated frequency band aggregated previously by P-PFL and other S-PFLs, the overlapping or colliding portion of the bandwidth of a new second aggregated frequency band formed by combining the S-PFL and the first aggregated frequency band should also be removed, that is, PRB_BA2=PRB_Bal+PRB_s-pfl2-PRB_overlap_bal_s-pfl2, as shown in FIG. 8; alternatively, it may also be equivalent to first determine actually occupied bandwidth (e.g., by removing overlapping or colliding portions) by multiple S-PFLs and then perform frequency aggregation with PFL to obtain the bandwidth size of the aggregated frequency band, as shown in FIG. 9;
the frequency domain starting location of the aggregated frequency band is determined according to the frequency domain starting location of the PRS resource set and/or PRS resources according to the P-PFL configuration, alternatively, the frequency domain starting location of the PRS resource set and/or PRS resources of the P-PFL configuration is determined as the frequency domain starting location of the aggregated frequency band, i.e., the frequency domain starting locations of the P-PFL configuration and the aggregated frequency band are the same, the frequency domain starting location includes the size of the corresponding startPRB, and/or a gap value between the starting location and a reference point, and the reference point may be PointA.

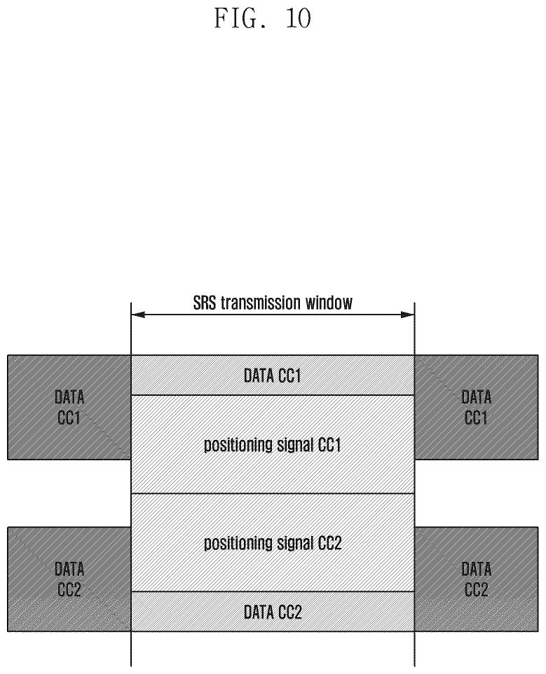

FIG. 10 illustrates a schematic diagram of a SRSpos transmission window according to an embodiment of the disclosure.

Referring to FIG. 10, receiving SRSpos transmission window (STW) related configuration information, where the introduction of the SRSpos transmission window is to create a time window in which SRSpos transmission with frequency band aggregation has priority on a CC (component carrier) used for normal data transmission, which can better ensure the transmission performance of SRSpos, for example, as shown in FIG. 10; the STW related configuration information may include at least one of:
an STW time domain length (i.e., the number of time domain units occupied)
an STW time domain starting location, including a time domain unit offset to a time domain reference point (e.g., X time domain units), where the time domain reference point may be a starting point of SFN0, or a starting point of a slot;
periodicity of STW, for example, one STW repeatedly occurs in every Y time domain units;
priority information, to indicate at least one of the following priority relationships within the STW;
the priority of SRSpos is higher than that of other non-positioning signals, when SRSpos collides or overlaps with other non-positioning signal transmissions, SRSpos is prioritized to be transmitted, which is beneficial for the scenario requiring SRSpos transmission to be prioritized; or
the priority of SRSpos is lower than that of other non-positioning signals, the other non-positioning signals may be particular signals, for example, random access related signals; when SRSpos collides or overlaps with other non-positioning signal transmissions, the other non-positioning signals are prioritized to be transmitted and/or received, which is beneficial for the scenario not requiring SRSpos transmission to be prioritized; or
the priority of the SRSpos is the same as that of other non-positioning signals, for example, when the priority of the SRSpos and other signals cannot be determined or does not need to be determined, the UE may determine to transmit SRSpos or receive or transmit other signals according to existing procedure or implementation;
alternatively, the priority information includes power allocation priority of signals within STW, if a total UE transmit power for PUSCH or PUCCH or PRACH or SRS transmissions on serving cells in a frequency range in a respective transmission occasion i would exceed P\hat{ }_CMAX (i), the UE allocates power to PUSCH/PUCCH/PRACH/SRS transmissions according to the following priority order (in descending order) so that the total UE transmit power for transmissions on serving cells in the frequency range is smaller than or equal to transmit power for that frequency range in every symbol of transmission occasion. The total UE transmit power in a symbol of a slot is defined as the sum of the linear values of UE transmit powers for PUSCH, PUCCH, PRACH, and SRS in the symbol of the slot.
PRACH transmission on the PCell
PUCCH or PUSCH transmissions with larger priority index

SRS transmission within SRS transmission window;
For PUCCH or PUSCH transmissions with same priority index
PUCCH transmission with HARQ-ACK information, and/or SR, and/or LRR, or PUSCH transmission with HARQ-ACK information of the priority index
PUCCH transmission with CSI or PUSCH transmission with CSI
PUSCH transmission without HARQ-ACK information of the priority index or CSI and, for Type-2 random access procedure, PUSCH transmission on the PCell
SRS transmission without SRS transmission window, with aperiodic SRS having higher priority than semi-persistent and/or periodic SRS, or single PRACH transmission on a serving cell other than the PCell

Any one PRACH transmission of multiple PRACH transmission on a serving cell other than PCell;
the SRSpos colliding or overlapping with other non-positioning signal transmission comprises:
the time domain unit occupied by SRSpos overlaps or collides with the time domain unit occupied by other non-positioning signals; or
the time domain unit occupied by adding a certain preparation time before or after SRSpos overlaps or collides with the time domain unit occupied by other non-positioning signals; and/or
alternatively, the time domain unit occupied by STW overlaps or collides with the time domain unit occupied by other non-positioning signals; or the time domain unit occupied by adding a certain preparation time before or after STW overlaps or collides with the time domain unit occupied by other non-positioning signals; and/or
alternatively, the time domain unit occupied by the first SRSpos in the STW overlaps or collides with the time domain unit occupied by other non-positioning signals; or the time domain unit occupied by adding a certain preparation time before or after the first SRSpos in the STW overlaps or collides with the time domain unit occupied by other non-positioning signals; and/or
alternatively, the time domain unit occupied may be replaced with a starting point or end point of the occupied time domain unit.

The certain period may be a time unit, a configuration period, and/or a measurement period, and/or a measurement gap, and/or a measurement window, and/or a positioning signal processing window (PPW).

Alternatively, the positioning signal is actually received or actually transmitted positioning signal; for example, when the positioning signal collides with other signal transmissions and cannot be received and/or transmitted, the positioning signal is free of a frequency hopping operation.

Wherein, the positioning signal may be replaced by multiple positioning signals or all positioning signals within the certain period, and/or can be replaced by one, multiple, or all repetition of the one or more positioning signals, and/or a frequency hopping of a positioning signal.

Determining a positioning signal to receive and/or transmit according to received configuration information of the positioning signal, comprising at least one of the following operations:

Determining the PRS frequency hopping (PRS hop) to measure (or receive) according to the received configuration information of the positioning signal

When the current activated BWP carries interrupting signal or interrupting time period, for example, there exists transmission or reception of other signals in the activated BWP related to PRS frequency hopping, or there exists periods used for other purposes in the activated BWP related to PRS frequency hopping, the UE needs to cancel the reception and measurement of the related PRS or PRS hop, or drop or give up the related PRS frequency hopping, as shown in FIG. 5, including at least one of:
the interrupting signal includes a random access related signal, at least including a message 1 or message A (preamble and/or PUSCH), and/or message 3, and/or PUCCH transmission corresponding to msg 4 (or msgB); and/or the message 2 (or message B) including corresponding PDCCH and/or PDSCH;
the interrupting time period at least includes an random access response window RAR window (or message B response window, msgB window; for example, 10 ms period) for searching for base station response in random access, and/or a period covered by a contention resolution timer;
the related PRS or PRS hop includes PRS and/or PRS hop overlapping (or colliding) with the interrupting signal (and/or the interrupting time period) in time domain and/or frequency domain, and/or PRS and/or PRS hop overlapping (or colliding) with preparation time (including X time units) before the interrupting signal (and/or the interrupting time period) in time domain; and/or PRS and/or PRS hop having overlapping portions (or colliding) with gap frequency band (including Y frequency domain units) above (or below) the interrupting signal (and/or the interrupting time period) in frequency domain;
the preparation time includes Z time units for preparing to receive or transmit the interrupting signal and/or preparing to receive or transmit the interrupting signal during the interrupting time period; and/or, switch time for switching back to prepare to receive or transmit the interrupting signal and/or be during the interrupting time period from the frequency domain location where the PRS or PRS hop is received (or the SRSpos or SRSpos is transmitted); and/or processing time for giving up PRS or PRS hop reception (or SRSpos or SRSpos hop transmission).

Determining the positioning signal to receive includes at least of:
determining a configuration index of the positioning signal to receive and/or transmit;
determining an index of the positioning signal to receive and/or transmit;
determining a time-frequency resource of the positioning signal to receive and/or transmit, including to determine the frequency hopping of the positioning signal to receive and/or transmit.

Performing reception and/or transmission of positioning signal, comprising at least one of:
the reception includes signal reception and/or measurement, and a result obtained by measurement includes at least one of:

Time domain related, e.g., TOA, TDOA, and/or;
Angle related, e.g., AOA, ZOA, OF Arrival, of Departure; and/or
Reception power related, RSRP or RSRPP;
Phase related, POA, PDOA, DPOA, or the like.

The reception may be a measurement result obtained for single frequency hopping and/or a measurement result obtained for M frequency hopping, where M is a positive integer and is obtained through predefinition and/or network device configuration. Alternatively, the way of predefinition includes the number of frequency hopping within the certain period, and/or the number of frequency hopping actually received and/or transmitted.

Alternatively, if the reception of one or more frequency hopping is cancelled, the UE reports the index of cancelled frequency hopping (or a logical index in a complete frequency hopping group) and/or index of actually received and measured or actually transmitted frequency hopping (a frequency hopping logical index of a positioning signal that is not cancelled in a complete frequency hopping group) in a reporting result. The frequency hopping index may be replaced by other representing PRS portions measured and received by a UE and/or SRSpos portions transmitted by the UE.

Alternatively, when a gap between two adjacent frequency hopping to be transmitted is less than a second threshold, the transmission of the latter frequency hopping is cancelled, where the second threshold is obtained by predefinition an/or obtained through network device configuration.

Reporting a measurement result obtained by receiving the positioning signal, where in a carrier phase positioning method,
when reporting the measurement results of multiple frequency domain locations related to the positioning signal is supported, for example, when reporting the measurement results of multiple frequency domain locations in a PFL, the specific operations may include at least one of:
the measurement result of the frequency domain location with the maximum or minimum frequency domain location is used as the reference result;
what is reported for other frequency domain locations is difference between measurement result of the other frequency domain locations and the reference result;
multiple frequency domain locations are determined according to certain criteria, including
the bandwidth occupied by the positioning signal is divided into N sub-bandwidths at equal intervals, the middle location, or the location of central sub-carrier, or the first or last sub-carrier of each sub-bandwidth is the frequency domain location; the value of N is a value configured by the network, alternatively, the value of N may be the maximum value of the multiple frequency domain locations to report configured by the network, i.e., the values of N frequency domain locations are reported at most; or
the bandwidth occupied by the positioning signal is divided into M sub-bandwidths according to the configured frequency domain interval (several frequency domain units), the location of the middle location, or the central sub-carrier, or the first or last sub-carrier of each sub-bandwidth is the frequency domain location; alternatively, when the network has configured the maximum value Nmax of the multiple frequency domain locations to report, i.e., the values of Nmax frequency domain locations are reported at most, when M is greater than Nmax value, the UE may
report Nmax measurement results for the first or last frequency domain locations; or
report the maximum Nmax or Nmax most accurate measurement results among the M measurement results, the most accurate result may be the Nmax measurement results with the minimum uncertainty range for the corresponding measurement results (e.g., the corresponding minimum integer fuzzy uncertainty range);
the bandwidth occupied by the positioning signal is indexed according to the number of sub-carriers (or other frequency domain units), and the corresponding frequency domain location is determined according to the received sub-carrier index (or other frequency domain unit indexes) corresponding to the frequency domain location;
the reported measurement results are in one-to-one correspondence with the frequency domain locations, that is, the frequency domain location information and the measurement result belong to the same reporting block, which is beneficial for a node receiving the report (e.g., base station or LMF) to understand the correspondence between the measurement result and the frequency domain location.

When reporting a phase difference among multiple sub-carriers, the specific operation includes at least one of:
Determining the reference sub-carrier to obtain a phase measurement value of the reference sub-carrier; wherein,
the determining reference sub-carrier may be determined by receiving a sub-carrier index value directly indicated by the network device; or
the determining reference sub-carrier may be obtained through certain criteria, specifically including taking the location of the central sub-carrier, or the first or last sub-carrier of the bandwidth occupied by the positioning signal as the reference sub-carrier;
determining the target sub-carrier to obtain a phase measurement value of the target sub-carrier; wherein,
the determining the target sub-carrier may be determined by receiving a sub-carrier index value directly indicated by the network device; or
the determining the target sub-carrier may be obtained according to the determined reference sub-carrier and sub-carrier spacing. For example, the X-th target sub-carrier index is equal to the reference sub-carrier index plus or minus X times of the sub-carrier spacing, i.e., SC_x=SC_ref+/−x*SC_offset;
the phase measurement value of the target sub-carrier minus the phase measurement value of the reference sub-carrier results in a phase difference therebetween; and the phase difference and/or the target sub-carrier index is reported to the network device, specifically,
the reported phase differences are in one-to-one correspondence to the reported target sub-carrier indexes, that is, a reported phase difference and a reported target sub-carrier index belong to the same reporting block, which is beneficial for the node receiving the report (e.g., base station or LMF) to understand the corresponding relationship between the reported phase difference value and the target sub-carrier index
reporting a reference sub-carrier index;
reporting a phase measurement value corresponding to the reference sub-carrier index.

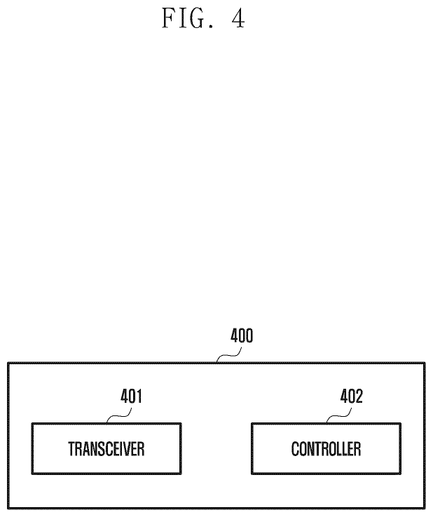

FIG. 4 is a block diagram of a communication device for performing a method according to an embodiment of the disclosure.

Referring to FIG. 4, a communication device 400 for a method for transmission and/or reception measurement of positioning signal is also provided by the embodiments of the disclosure, the communication device may be user equipment or a base station device. The communication device includes a transceiver 401, and a controller 402. Alternatively, the communication device may also include memory (not shown). The transceiver 401 is used to transmit and/or receive signals or data. A computer executable instruction is stored on the memory. When the instruction is performed by the controller 402, the communication device may execute at least one method corresponding to each embodiment of the disclosure. The above is only the example embodiment of the disclosure, and is not used to limit the disclosure. Any modification, equivalent substitution, improvement, or the like, made within the spirit and principle of the disclosure should be included in the scope of protection of the disclosure.

It may be understood by those skilled in the art that the disclosure includes devices for performing one or more of the operations described in this application. These devices may be specially designed and manufactured for required purposes, or may include known devices in general-purpose computers. These devices have computer programs stored therein, which are selectively activated or reconfigured. Such computer programs may be stored in a device (e.g., a computer) readable medium or in any type of medium suitable for storing electronic instructions and respectively coupled to a bus. The computer readable medium includes, but is not limited to, any type of disk (including floppy disk, hard disk, optical disk, CD-ROM, and magneto-optical disk), read-only memory (ROM), random access memory (RAM), erasable programmable read-only memory (EPROM), electrically erasable programmable read-only memory (EEPROM), flash memory, a magnetic card, or optical card. This is to say, the readable medium includes any medium in which information is stored or transmitted by a device (e.g., a computer) in a readable form.

It may be understood by those skilled in the art that the computer instructions may be used to implement each block in these structural diagrams and/or block diagrams and/or flowcharts as well as a combination of blocks in these structural diagrams and/or block diagrams and/or flowcharts. It may be understood by those skilled in the art that these computer program instructions may be provided to general-purpose computers, special-purpose computers or other processors of programmable data processing means to be implemented, thus performing solutions designated in a block or blocks of the structure diagrams and/or block diagrams and/or flow diagrams by computers or other processors of programmable data processing means.

It may be understood by those skilled in the art that the operations, methods, steps in the flows, measures and solutions already discussed in the disclosure may be alternated, changed, combined or deleted. Further, the operations, methods, other steps in the flows, measures and solutions already discussed in the disclosure may also be alternated, changed, rearranged, decomposed, combined or deleted. Further, prior arts having the operations, methods, the steps in the flows, measures and solutions already discussed in the disclosure may also be alternated, changed, rearranged, decomposed, combined or deleted.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by user equipment (UE) in a communication system, comprising:
receiving first configuration information related to positioning signal;
determining a first frequency band and a second frequency band based on the first configuration information;
determining resource configuration information of a third frequency band based on the first frequency band and the second frequency band; and
transmitting and/or receiving the positioning signal based on the resource configuration information of the third frequency band.

2. The method of claim 1, wherein the first configuration information related to positioning signal comprises at least one of:
positioning signal configuration information associated with frequency band aggregation;
indication information for activating frequency band aggregation;
configuration information of a plurality of positioning frequency layers (PFLs) for frequency band aggregation; or
configuration information related to a sounding reference signal (SRS) for positioning transmission window (STW).

3. The method of claim 1, wherein the determining of the first frequency band and the second frequency band based on the first configuration information related to positioning signal comprises:
determining the first frequency band or the second frequency band based on indication information related to the first frequency band or the second frequency band in the first configuration information related to positioning signal, or
determining the first frequency band or the second frequency band based on a positioning reference signal (PRS) resource set or PRS resources included in the first configuration information related to positioning signal, or a cell index or TRP index associated with PFL configuration information.

4. The method of claim 3, wherein the determining of the first frequency band or the second frequency band based on a positioning reference signal (PRS) resource set or PRS resources included in the first configuration information related to positioning signal, comprises:
determining the first frequency band or the second frequency band based on at least one of a number of positioning reference signal (PRS) resource sets or PRS resources in a configuration related to positioning signal, a frequency domain start position, a size of a start physical resource block (PRB), an interval between the start PRB and a reference point (Point A), and bandwidth size.

5. The method of claim 1, further comprising:
determining resource configuration information of the first frequency band and the second frequency band based on the first configuration information related to positioning signal; and
determining resource configuration information of a third frequency band based on the first frequency band and the second frequency band comprises: determining the resource configuration information of the third frequency band based on the resource configuration information of the first frequency band and the second frequency band.

6. The method of claim 5, wherein the determining of the resource configuration information of the third frequency band based on the resource configuration information of the first frequency band and the second frequency band, comprises:
determining time domain configuration information of the third frequency band according to time domain configuration information of the first frequency band; and
determining frequency domain configuration information of the third frequency band according to frequency domain configuration information of the first frequency band and the second frequency band.

7. The method of claim 1, further comprising:
receiving second configuration information related to positioning signal;
determining positioning reference signal (PRS) frequency hopping based on the second configuration information; and
if a first condition related to interrupting signal or interrupting time period is satisfied, canceling a reception of a part or all of the PRS frequency hopping or dropping the part or all of the PRS frequency hopping.

8. The method of claim 7, wherein the first condition comprises at least one of:
an activated bandwidth portion band width part (BWP) corresponding to the PRS frequency hopping carries an interrupting signal or interrupting time period;
the PRS frequency hopping overlaps or collides with the interrupting signal or interrupting time period in time domain and/or frequency domain;
an interval between the PRS frequency hopping and the interrupting signal or interrupting time period in time domain and/or frequency domain is less than a third threshold; or
the interrupting signal adding a fourth threshold in time domain or frequency domain overlaps or collides with the PRS frequency hopping.

9. The method of claim 8, wherein the third threshold or the fourth threshold is related to at least one of:
preparation time for preparing to receive or transmit the interrupting signal,
switch time for switching to a frequency domain location for receiving the interrupting signal, or
time for canceling the reception of the PRS frequency hopping, or a frequency domain interval between different frequency hopping.

10. The method of claim 1, further comprising:
determining a plurality of frequency domain locations related to positioning signal;
acquiring measurement results of the plurality of frequency domain locations; and
reporting first information related to the measurement result of each of the plurality of frequency domain locations to a base station.

11. The method of claim 10, further comprising:
reporting measurement results of other frequency domain locations among the plurality of frequency domain locations based on a measurement result of a reference frequency domain location among the plurality of frequency domain locations,
wherein the reference frequency domain location is a maximum or minimum frequency domain location among the plurality of frequency domain locations, or an indicated reference frequency domain location.

12. The method of claim 10, wherein the determining of the plurality of frequency domain locations related to positioning signal comprises:
obtaining the plurality of frequency domain locations by dividing a bandwidth occupied by the positioning signal at equal intervals according to a configured first number N;
obtaining the plurality of frequency domain locations by dividing a bandwidth occupied by the positioning signal according to a configured frequency domain interval; or
determining the plurality of frequency domain locations based on information related to a plurality of sub-carriers.

13. The method of claim 10, wherein the first information further comprises indication information of the plurality of frequency domain locations, or the indication information of the plurality of frequency domain locations and the first information are separately indicated to a base station.

14. A method performed by a base station in a wireless communication system, the method comprising:
transmitting first configuration information related to positioning signal; and
transmitting and/or receiving the positioning signal based on the first configuration information;
wherein the first configuration information is used to determine a first frequency band and a second frequency band, and resource configuration information of a third frequency band related to the first frequency band and the second frequency band, and
wherein the positioning signal is transmitted and/or received based on the resource configuration information of the third frequency band.

15. The method of claim 14, wherein the first configuration information related to positioning signal comprises at least one of:
positioning signal configuration information associated with frequency band aggregation;
indication information for activating frequency band aggregation;
configuration information of a plurality of positioning frequency layers (PFLs) for frequency band aggregation; or
configuration information related to a sounding reference signal (SRS) for positioning transmission window (STW).

16. The method of claim 14, further comprising:
transmitting second configuration information related to positioning signal; and
transmitting positioning reference signal (PRS) frequency hopping based on the second configuration information;
wherein, if a first condition related to interrupting signal or interrupting time period is satisfied, a reception of a part or all of PRS frequency hopping is cancelled or dropped.

17. The method of claim 16, wherein the first condition comprises at least one of:
an activated bandwidth portion BWP corresponding to the PRS frequency hopping carries interrupting signal or interrupting time period;
the PRS frequency hopping overlaps or collides with the interrupting signal or interrupting time period in time domain and/or frequency domain,
an interval between the PRS frequency hopping and the interrupting signal or interrupting time period in time domain and/or frequency domain is less than a third threshold; or
the interrupting signal adding a fourth threshold in time domain or frequency domain overlaps or collides with the PRS frequency hopping.

18. The method of claim 17, wherein the third threshold or the fourth threshold is related to at least one of:
preparation time for preparing to receive or transmit the interrupting signal,
switch time for switching to a frequency domain location for receiving the interrupting signal, or
time for canceling the reception of the PRS frequency hopping, or a frequency domain interval between different frequency hopping.

19. The method of claim 14, further comprising:
transmitting information related to a plurality of frequency domain locations related to a measurement of positioning signal; and
receiving first information related to a measurement result of each of the plurality of frequency domain locations.

20. The method of claim 19, wherein the information related to the plurality of frequency domain locations comprises at least one of:
information related to a first number N of the plurality of frequency domain locations;
a frequency domain interval related to the plurality of frequency domain locations; or
information related to a plurality of sub-carriers.
